(19) United States
(12) Patent Application Publication
(10) Pub. No.: US 2024/0203277 A1
(43) Pub. Date: Jun. 20, 2024

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: RINNA KANAO, TOKYO (JP); YUMA HIRAI, TOKYO (JP); GENKI OKADA, TOKYO (JP); DAISUKE INAISHI, TOKYO (JP)

(21) Appl. No.: 18/556,045

(22) PCT Filed: May 10, 2021
(86) PCT No.: PCT/JP2021/017649

§ 371 Date: Oct. 18, 2023

(51) Int. Cl. G09B 5/02; G10L 15/08

(52) U.S. Cl. CPC G09B 5/02; G10L 15/08

(57) ABSTRACT

An information processing device including a template setting unit that sets a plurality of items forming a speech and an order in which the items should be spoken as a speech template, and a presentation processing unit that performs processing of presenting the template to a user.

### TECHNICAL FIELD

The present technology relates to an information processing device, an information processing method, and an information processing program.

### BACKGROUND ART

Conventionally, a technology of presenting a manner of speaking irrespective of practice and actual speech has been required; however, the manner of speaking is personalized and its know-how is difficult, so that it is general to be instructed by a specific individual in order to learn an appropriate manner of speaking.

Furthermore, the manner of speaking is difficult to objectively and quantitatively evaluate, and there also is a problem that it takes a lot of cost if a specific individual's instruction is continuously received.

As a technology regarding the manner of speaking and conversation, there is UI display in conversation support (Patent Document 1).

### CITATION LIST

### Patent Document

Patent Document 1: Japanese Patent Application Laid-Open No. 2019-197293

### SUMMARY OF THE INVENTION

### Problems to be Solved by the Invention

However, there is an unsolved problem that it is not possible to practice the speech by the technology disclosed in Patent Document 1.

The present technology has been achieved in view of such a point, and an object thereof is to provide an information processing device, an information processing method, and an information processing program that provide an objective speech practice method, support in actual speech and the like without requiring instruction by a specific individual.

### Solutions to Problems

In order to solve the above-described problem, a first technology is an information processing device including a template setting unit that sets a plurality of items forming a speech and an order in which the items should be spoken as a speech template, and a presentation processing unit that performs processing of presenting the template to a user.

Furthermore, a second technology is an information processing method including setting a plurality of items forming a speech and an order in which the items should be spoken as a speech template, and performing processing of presenting the template to a user.

Furthermore, a third technology is a program that allows a computer to execute an information processing method including setting a plurality of items forming a speech and an order in which the items should be spoken as a speech template, and performing processing of presenting the template to a user.

### BRIEF DESCRIPTION OF DRAWINGS

FIG. 1 is a block diagram illustrating a configuration of an information processing system 10.

FIG. 2 is a block diagram illustrating a configuration of a terminal device 100.

FIG. 3 is a block diagram illustrating a configuration of an information processing device 200.

FIG. 4 is a block diagram illustrating a configuration of an evaluation processing unit 230.

FIG. 5 is a block diagram illustrating a configuration of a server device 300.

FIG. 6 is an explanatory diagram of a template.

FIG. 7 is a flowchart of template setting processing.

FIG. 8 is a flowchart of template setting processing.

FIG. 9 is a flowchart of template setting processing.

FIG. 10 is an explanatory diagram of a template.

FIG. 11 is a diagram illustrating a first aspect of presentation of a template.

FIG. 12 is a flowchart of template presentation processing.

FIG. 13 is a diagram illustrating item addition in a presentation aspect of a template.

FIG. 14 is a flowchart of template presentation processing.

FIG. 15 is a flowchart of template presentation processing.

FIG. 16 is a flowchart of template presentation processing.

FIG. 17 is a flowchart of template presentation processing.

FIG. 18 is a diagram illustrating presentation of an example sentence in a presentation aspect of a template.

FIG. 19 is a diagram illustrating a second aspect of presentation of a template.

FIG. 20 is a diagram illustrating the second aspect of presentation of a template.

FIG. 21 is a diagram illustrating presentation of an example sentence in the second aspect of presentation of a template.

### MODE FOR CARRYING OUT THE INVENTION

Hereinafter, embodiments of the present technology will be described with reference to the drawings. Note that, the description will be given in the following order.
<1. Embodiment>
[1-1. Configuration of Information Processing System 10]
[1-2. Configuration of Terminal Device 1000]
[1-3. Configuration of Information Processing Device 200]
[1-4. Configuration of Server Device 300]
[1-5. Processing by Information Processing Device 200]
[1-5-1. Template Setting Processing]
[1-5-2. Template Presentation Processing]

<2. Variation>

### 1. Embodiment

### [1-1. Configuration of Information Processing System 10]

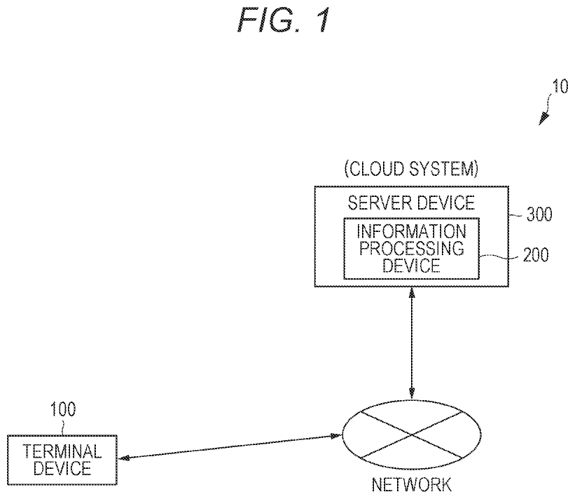

A configuration of an information processing system 10 will be described with reference to FIG. 1. The information processing system 10 includes a terminal device 100, an information processing device 200, and a server device 300.

The terminal device 100 is used by a user who practices speech or receives support in actual speech using the present technology, and displays a speech template, an utterance content of the user himself/herself and the like to present the same to the user.

Furthermore, the terminal device 100 includes a camera 106 and a microphone 107, acquires a voice uttered by the user who is speaking and an image or a video obtained by imaging a figure of the user, and transmits the same to the information processing device 200.

The information processing device 200 receives the utterance content of the user and the image or the video obtained by imaging the figure of the user who is speaking from the terminal device 100, and provides the user with a practice method of the speech, supports the user in the actual speech and the like. The information processing device 200 operates in the server device 300, and the provision of the practice method and the support in the actual speech are provided to the user as, for example, a cloud service.

The utterance content of the user who is speaking and the image or the video obtained by imaging the figure of the user are transmitted to the information processing device 200 in real time, and are reflected to the speech practice and the support of the actual speech. Furthermore, a recognition result and the like of the utterance content of the user in the information processing device 200 is transmitted to the terminal device 100 in real time and presented to the user.

### [1-2. Configuration of Terminal Device 100]

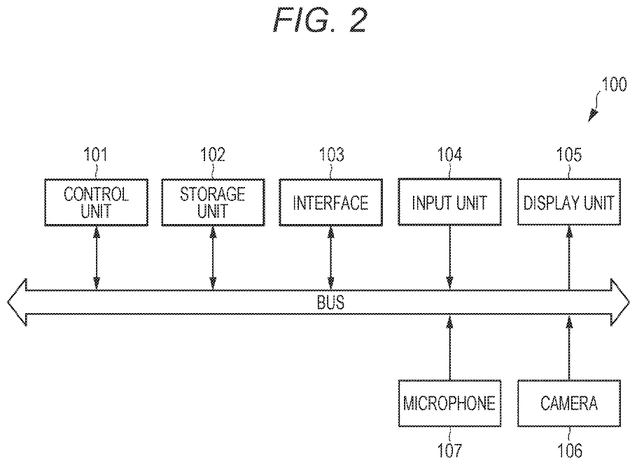

Next, a configuration of the terminal device 100 will be described with reference to FIG. 2.

The terminal device 100 includes a control unit 101, a storage unit 102, an interface 103, an input unit 104, a display unit 105, the camera 106, and the microphone 107.

The control unit 101 includes a central processing unit (CPU), a random access memory (RAM), a read only memory (ROM) and the like. The CPU executes various types of processing according to a program stored in the ROM and issues commands, thereby controlling an entire terminal device 100 and each unit thereof.

The storage unit 102 is, for example, a large-capacity storage medium such as a hard disk or a flash memory. The storage unit 102 stores various applications operated in the terminal device 100, various pieces of information used by the information processing device 200 and the like.

The interface 103 is an interface with another device, a network and the like. The interface 103 might include a wired or wireless communication interface. Furthermore, more specifically, the wired or wireless communication interface might include cellular communication such as 3TTE, Wi-Fi, Bluetooth (registered trademark), near field communication (NFC), Ethernet (registered trademark), high-definition multimedia interface (HDMI (registered trademark)), universal serial bus (USB) and the like.

The input unit 104 is used by the user for inputting various instructions and the like to the terminal device 100. When the user inputs to the input unit 104, a control signal corresponding to the input is generated and supplied to the control unit 101. Then, the control unit 101 performs various types of processing corresponding to the control signal. In addition to physical buttons, the input unit 104 includes a touch panel, voice input by voice recognition, gesture input by human body recognition and the like.

The display unit 105 is a display device such as a display that displays the speech template, a graphical user interface (GUI) and the like.

The camera 106 includes a lens, an imaging element, a signal processing circuit and the like, and is used to image the user who practices the speech and receives the support in the actual speech.

The microphone 107 is for recording the voice uttered by the user who is speaking.

Note that, in a case where the terminal device 100 does not include the camera 106 and the microphone 107, a camera and a microphone separate from the terminal device 100 are necessary. In a case where the camera and the microphone are independent devices separate from the terminal device 100, the camera and the microphone need to be connected to the terminal device 100 or the server device 300 via a wired or wireless network.

The terminal device 100 includes, for example, a smartphone, a tablet terminal, a personal computer and the like. Note that, in a case where the terminal device 100 is the smartphone, the tablet terminal, or the personal computer, these devices usually include a camera and a microphone, so that a camera and a microphone as separate independent devices are unnecessary.

Note that, the terminal device 100 may include both the camera 106 and the microphone 107, or the terminal device 100 may include only one of the camera 106 and the microphone 107, and the other may be an independent device separate from the terminal device 100. Furthermore, both the camera 106 and the microphone 107 may be independent devices separate from the terminal device 100.

Furthermore, the terminal device 100 that displays the template, the utterance content of the user himself/herself in the speech practice and actual speech and the like, and presents the same to the user, and the terminal device 100 that includes the camera 106 and the microphone 107 and transmits the voice uttered by the user who is speaking and the image or video obtained by imaging the figure of the user to the information processing device 200 may be separate devices.

### [1-3. Configuration of Information Processing Device 200]

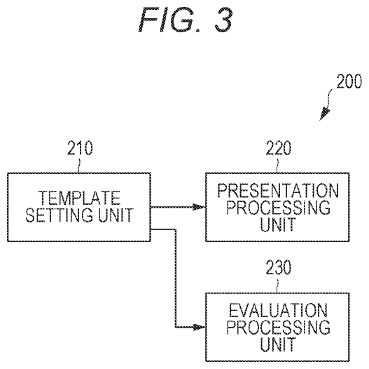

A configuration of the information processing device 200 will be described with reference to FIG. 3.

The information processing device 200 includes a template setting unit 210, a presentation processing unit 220, and an evaluation processing unit 230.

The template setting unit 210 sets the speech template to be presented to the user. The template includes items indicating the content of the speech that the user should speak and an optimal order in a case where the items are spoken. The template will be described later in detail.

The presentation processing unit 220 performs template presentation processing for displaying the template set by the template setting unit 210 on the display unit 105 of the terminal device 100 and presenting the template to the user. Data for template display generated by the template presentation processing is transmitted to the terminal device 100 via the network, and the terminal device 100 performs display processing on the basis of the data for template display, so that the template is displayed on the display unit 105 and presented to the user.

The evaluation processing unit 230 evaluates the content uttered by the user on the basis of the template.

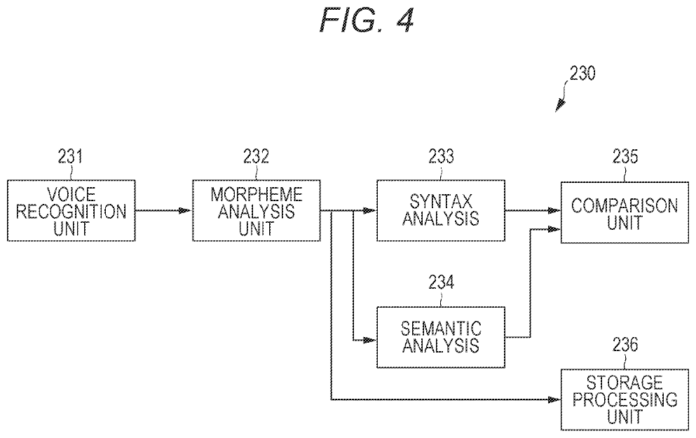

As illustrated in FIG. 4, the evaluation processing unit 230 includes a voice recognition unit 231, a morpheme analysis unit 232, a syntax analysis unit 233, a semantic analysis unit 234, a comparison unit 235, and a storage processing unit 236.

The voice recognition unit 231 recognizes a character string as the utterance content from the voice of the user input via the microphone 107 by a known voice recognition function.

The morpheme analysis unit 232 performs morpheme analysis on the utterance content recognized by the voice recognition unit 231. The morpheme analysis is processing of dividing the utterance content into morphemes, which are minimum units having meanings in language, on the basis of information such as grammar of a target language and a part of speech of a word, and discriminating the part of speech and the like of each morpheme. The utterance content subjected to the morpheme analysis is supplied to the syntax analysis unit 233 and the semantic analysis unit 234.

The syntax analysis unit 233 performs syntax analysis processing on the utterance content subjected to the morpheme analysis. The syntax analysis is processing of determining a relationship between words such as modifiers and modified words on the basis of grammars and syntax, and expressing the relationship by some data structure, schematization and the like.

The semantic analysis unit 234 performs semantic analysis processing on the utterance content subjected to the morpheme analysis. The semantic analysis is processing of determining a correct connection between a plurality of morphemes on the basis of the meaning of each morpheme. By the semantic analysis, a semantically correct syntax tree is selected from a plurality of patterns of syntax trees.

Note that, the syntax analysis unit 233 and the semantic analysis unit 234 can be implemented by machine learning, deep learning and the like.

The comparison unit 235 compares the utterance content of the user with the template on the basis of a syntax analysis result and a semantic analysis result, and evaluates the utterance content of the user. The evaluation includes a matching degree and a deviation between the utterance content and the items, a matching degree and a deviation between the utterance content and an example sentence, and a matching degree and a deviation between the order to be spoken of the items in the template and the order in the utterance content of the user.

The storage processing unit 236 stores text data indicating the utterance content subjected to the morpheme analysis in association with the template. The storage processing unit 236 may store the text data in the storage unit 302 of the server device 300, or may store the text data in the storage processing unit 236 itself in a case where the storage processing unit 236 includes a storage medium.

The information processing device 200 is formed as described above. The information processing device 200 may be formed as a single device or may be implemented by execution of a program. The program that performs processing regarding the information processing device 200 may be installed in the server device 300 in advance, or may be downloaded or distributed on a storage medium and the like, and installed by a manager of the server device 300, a business operator and the like.

### [1-4. Configuration of Server Device 300]

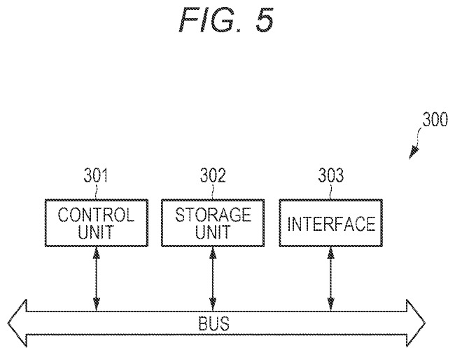

A configuration of the server device 300 is described with reference to FIG. 5. The server device 300 at least includes a control unit 301, a storage unit 302, and an interface 303. The information processing device 200 communicates with the terminal device 100 using the interface 303 included in the server device 300.

The control unit 301 includes a CPU, a RAM, a ROM and the like. The ROM stores a program and the like that are read and operated by the CPU. The RAM is used as a work memory of the CPU. The CPU executes various types of processing in accordance with the program stored in the ROM and issues commands, thereby controlling an entire server device 300 and each unit. In a case where the information processing device 200 operates in the server device 300, the template setting unit 210, the presentation processing unit 220, and the evaluation processing unit 230 are implemented by processing in the control unit 301.

The storage unit 302 is, for example, a large-capacity storage medium such as a hard disk and a flash memory.

The interface 303 is an interface with the terminal device 100 and the Internet. The interface 303 might include a wired or wireless communication interface.

The server device 300 is formed as described above. By implementing the information processing device 200 as processing in the server device 300, processing by the information processing device 200 can be provided to the user as a cloud service.

The cloud is one of use forms of a computer, and is constructed in a server of a cloud service provider, for example. Basically, all necessary processing is performed on the server side. The user stores the data in the server on the Internet instead of the user's own device and the like. Therefore, it is possible to use services, use data, edit data, upload data, and the like in various environments such as a home, a company, an outside place, an imaging site, and an editing room. Furthermore, the cloud system can also transfer various data and the like between devices connected via a network.

Note that, the information processing device 200 itself may include a control unit, a storage unit, and an interface.

### [1-5. Processing by Information Processing Device 200]

### [1-5-1. Template Setting Processing]

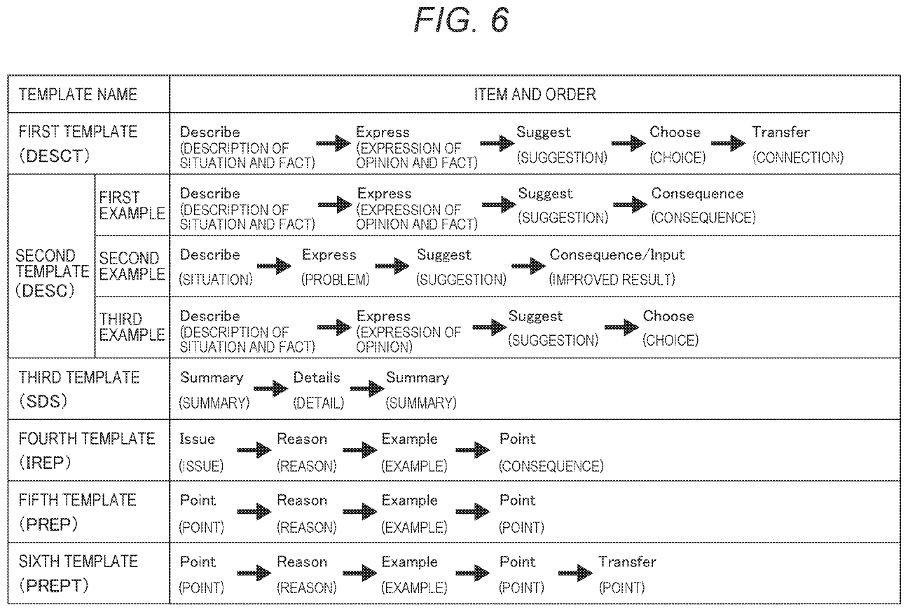

Next, the processing by the information processing device 200 will be described. The template includes items indicating the content of the speech that the user should speak and an optimal order in a case where the items are spoken. In this embodiment, as illustrated in FIG. 6, six templates are prepared in advance. In FIG. 6, a name of each template and a plurality of items in each template are illustrated, and further, arrows indicate the order to be spoken of the plurality of items. It is assumed that the information processing device 200 holds the plurality of templates in advance.

A first template indicates items of Describe (description of situation and fact), Express (expression of opinion and fact), Suggest (suggestion), Choose (choice), and Transfer (connection) and the order thereof. In the following description, there is a case where the first template is referred to as DESCT by combining initial letters of the respective items.

Furthermore, a first example of a second template indicates items of Describe (description of situation and fact), Express (expression of opinion and fact), Suggest (suggestion), and Consequence (consequence) and the order thereof. Furthermore, a second example of the second template indicates items of Describe (situation), Express (problem), Suggest (suggestion), and Consequence/Input (improved result) and the order thereof. Moreover, a third example of the second template indicates items of Describe (description of situation and fact), Express (expression of opinion), Suggest (suggestion), and Choose (choice) and the order thereof. The first, second, and third examples of the second template can be selectively used in such a manner that, for example, in a case where the second template is used alone, the first example or the second example is used, and in a case where the second template is used in combination with another template, the third example is used. In the following description, there is a case where the second template is referred to as DESC by combining initial letters of the respective items.

A third template indicates items of Summary (summary), Details (detail), and Summary (summary) and the order thereof. In the following description, there is a case where the third template is referred to as SDS by combining initial letters of the respective items.

A fourth template indicates items of Issue (issue), Reason (reason), Example (example), and Point (consequence) and the order thereof. In the following description, there is a case where the fourth template is referred to as IREP by combining initial letters of the respective items.

A fifth template indicates items of Point (point), Reason (reason), Example (example), and Point (point) and the order thereof. In the following description, there is a case where the fifth template is referred to as PREP by combining initial letters of the respective items.

A sixth template indicates items of Point (point), Reason (reason), Example (example), Point (point), and Transfer (connection) and the order thereof. In the following description, there is a case where the sixth template is referred to as PREPT by combining initial letters of the respective items.

The first to sixth templates described above can be used alone as a template of a one-dimensional matrix, or it is also possible to combine two templates and use as a new template of a two-dimensional matrix. Moreover, three or more templates may be combined to form a new template.

Note that, the template illustrated in FIG. 6 is merely an example, and the present technology is not limited to these templates. Furthermore, the template may be added, deleted, or edited by the user, a business operator that provides the speech practice and a support service using the information processing device 200 and the like.

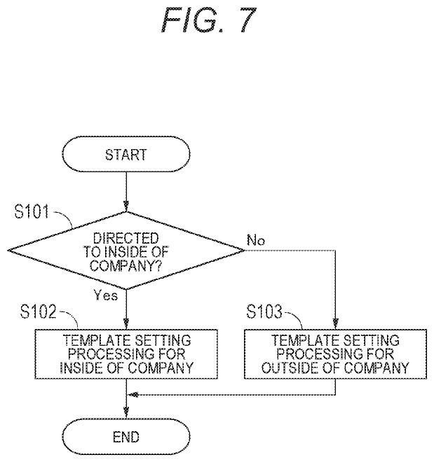

Template setting processing by the template setting unit 210 will be next described with reference to flowcharts in FIGS. 7 to 9. In each branch in the template setting processing, options are presented to the user via the terminal device 100, and processing is performed on the basis of a selection result of the user from the options.

First, at step S101 of the processing illustrated in FIG. 7, options whether the user's speech is directed to the inside of the company or the outside of the company are presented, and in a case where the speech is directed to the inside of the company, the processing proceeds to step S102, and the template setting processing of the speech directed to the inside of the company is performed.

In contrast, in a case where the speech is directed to the outside of the company, the processing proceeds to step S103, and the template setting processing of the speech directed to the outside of the company is performed. In this manner, in this embodiment, first, the setting is performed according to whether the user's speech is directed to the inside or the outside of the company. This is because the template to be presented to the user is different.

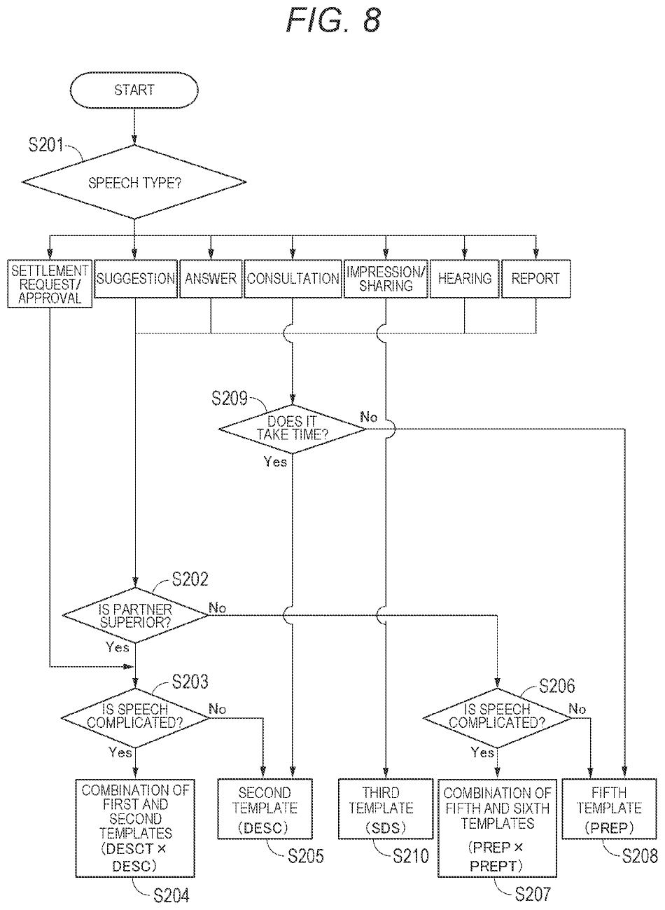

Next, with reference to FIG. 8, the template setting processing of the speech directed to the inside of the company is performed.

First, at step S201, the user presents options indicating speech types. Examples of the speech types include suggestion, answer, consultation, impression/sharing, hearing, report, and settlement request/approval, for example. Note that, these speech types are merely examples, and the present technology is not limited to these speeches.

In a case where the user selects any one of the suggestion, the answer, the hearing, and the report, next, at step S202, a selection input as to whether or not a speech partner of the user is superior in a relationship with the user is accepted. A case where the speech partner is a superior is a case where the speech partner is a boss, and a case where the speech partner is not a superior is a case where the speech partner is a colleague or an inferior. Note that, the speech partner is merely an example, and the present technology is not limited to this speech partner. In a case where the speech partner is the superior, the processing proceeds to step S203 (Yes at step S202).

Next, in a case where the speech content is complicated at step S203, the processing proceeds to step S204 (Yes at step S203). Then, at step S204, a “combination of the first template and the second template” is set as the speech template.

In contrast, in a case where the speech content is not complicated at step S203, the processing proceeds to step S205 (No at step S203). Then, at step S203, the template setting unit 210 sets the “second template” as the speech template.

Returning to step S202, in a case where the speech partner is not the superior, the processing proceeds to step S206 (No at step S202).

Next, in a case where the speech content is complicated at step S206, the processing proceeds to step S207 (Yes at step S206). Then, at step S207, the template setting unit 210 sets a “combination of the fifth template and the sixth template” as the speech template.

In contrast, in a case where the speech is not complicated at step S206, the processing proceeds to step S208 (No at step S206). Then, at step S208, the template setting unit 210 sets the “fifth template” as the speech template.

Returning to step S201 again, in a case where the user selects the consultation as the speech type, the processing proceeds to step S209. In a case where it is assumed that there is a time for speaking at step S209, the processing proceeds to step S205 (Yes at step S209). Then, at step S209, the template setting unit 210 sets the “second template” as the speech template.

In contrast, in a case where it is assumed that there is no time for speaking at step S209, the processing proceeds to step S208 (No at step S209). Then, at step S208, the template setting unit 210 sets the “fifth template” as the speech template.

Returning to step S201, in a case where the user selects the impression/sharing as the speech type, the processing proceeds to step S210, and the “third template” is set as the speech template.

Returning to step S201, in a case where the user selects the settlement request/approval as the speech type, the processing proceeds to step S203.

In a case where the speech is complicated at step S203, the processing proceeds to step S204 (Yes at step S203). Then, at step S204, the template setting unit 210 sets a “combination of the first template and the second template” as the speech template.

In contrast, in a case where the speech is not complicated at step S203, the processing proceeds to step S205 (No at step S203). Then, at step S205, the template setting unit 210 sets the “second template” as the speech template.

As described above, the template setting processing of the speech directed to the inside of the company is performed.

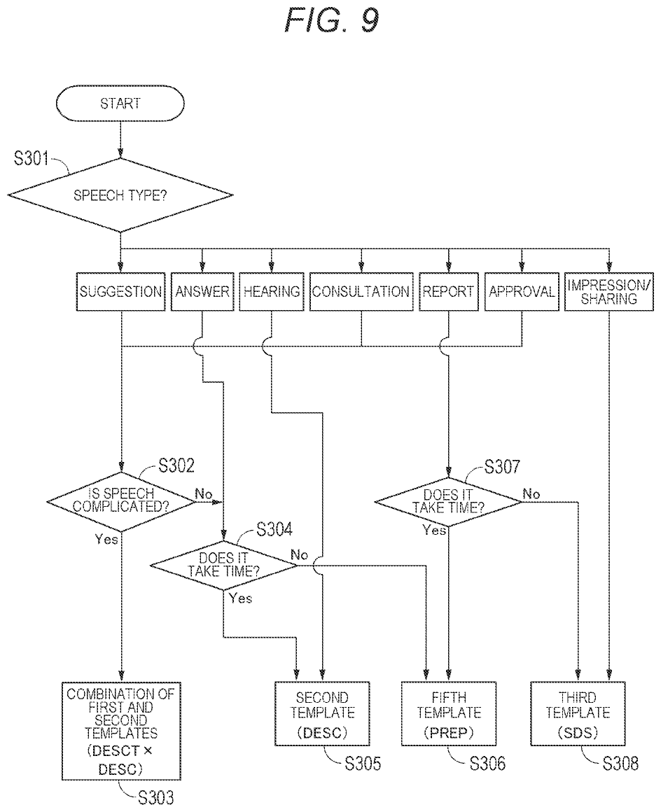

Next, with reference to FIG. 9, the template setting processing of the speech directed to the outside of the company is described. First, at step S301, options indicating the speech types are presented. Examples of the speech types include suggestion, answer, hearing, consultation, report, approval, and impression/sharing, for example. Note that, these speech types are merely examples, and the present technology is not limited to these speeches.

In a case where the user selects any one of the suggestion, the consultation, and the approval, the processing next proceeds to step S302. At step S302, in a case where the speech is complicated, the processing proceeds to step S303 (Yes at step S302), and a “combination of the first template and the second template” is set as the speech template.

In contrast, in a case where the speech is not complicated at step S302, the processing proceeds to step S304 (No at step S302).

At step S304, in a case where it is assumed that there is a time for speaking, the processing proceeds to step S305 (Yes at step S304), and the template setting unit 210 sets the “second template” as the speech template.

In contrast, in a case where the speech is not complicated at step S304, the processing proceeds to step S306 (No at step S304), and the template setting unit 210 sets the “fifth template” as the speech template.

Returning to step S301, in a case where the user selects the answer as the speech type, the processing proceeds to step S304. Then, the processing after step S304 is similar to that described above.

Returning to step S301, in a case where the user selects hearing as the speech type, the processing proceeds to step S305, and the template setting unit 210 sets the “second template” as a speech template.

Returning to step S301, in a case where the user selects the report as the speech type, the processing proceeds to step S307.

In a case where it is assumed that there is a time for speaking at step S307, the processing proceeds to step S306 (Yes at step S307), and the template setting unit 210 sets the “fifth template” as the speech template.

In contrast, in a case where it is assumed that there is little time at step S307, the processing proceeds to step S308 (No at step S307), and the template setting unit 210 sets the “third template” as the speech template.

Returning to step S301, in a case where the user selects the impression/sharing as the speech type, the processing proceeds to step S308, and the template setting unit 210 sets the “third template” as the speech template.

As described above, the template setting processing of the speech directed to the outside of the company is performed. Note that, although it is described that the template setting processing is performed on the basis of the selection result of the user from the options, in addition, the template may be automatically set by machine learning from, for example, scripts, documents, a situation of a meeting where the user attends, attendance information of the meeting and the like.

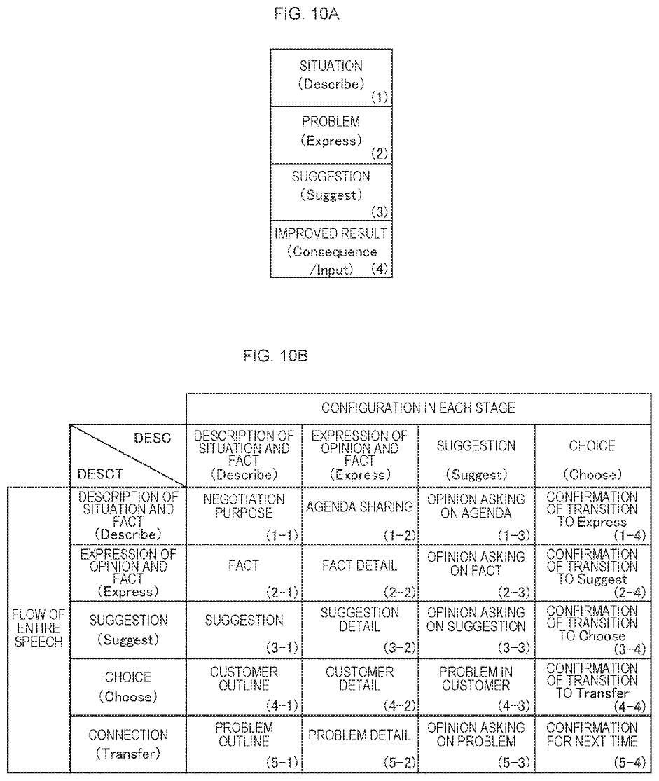

When the template setting unit 210 sets the second example of the second template as the speech template, the items and the order in which the items should be spoken are as illustrated in FIG. 10A. Numbers (1), (2), (3), and (4) indicate the order in which the items should be spoken.

Furthermore, when the template setting unit 210 sets the template of the two-dimensional matrix by combining the first template and the second template, the items forming the template and the order in which the items should be spoken are as illustrated in FIG. 10B. Note that, as described above, the second template includes the first, second, and third examples, and an artificial intelligence (AI) may determine the example to be used according to the situation and suggest the same to the user.

In the template in FIG. 10B, the order of the items is, first, in a row of “Describe”, negotiation purpose (1-1), agenda sharing (1-2), opinion asking on agenda (1-3), and confirmation of transition to Express (1-4).

Furthermore, in a row of “Express”, the order in which the items should be spoken is fact (2-1), fact detail (2-2), opinion asking on fact (2-3), and confirmation of transition to Suggest (2-4).

Furthermore, in a row of “Suggest”, the order in which the items should be spoken is suggestion (3-1), suggestion detail (3-2), opinion asking on suggestion (3-3), and confirmation of transition to Choose (3-4).

Furthermore, in a row of “Choose”, the order in which the items should be spoken is customer outline (4-1), customer detail (4-2), problem in customer (4-3), and confirmation of transition to Transfer (4-4).

Then, in a row of “Transfer”, the order in which the items should be spoken is problem outline (5-1), problem detail (5-2), opinion asking on problem (5-3), and confirmation for next time (5-4). The confirmation for next time is, for example, confirmation for a next meeting, a next simulated practice meeting and the like.

Note that, in the above description, it is described that the template setting processing is performed on the basis of the selection result of the user from the options to the user, but this may be performed on the basis of the input content of the user without presenting the options to the user.

Note that, in the above description, the template setting processing is performed for the inside of the company or the outside of the company, but they are merely examples, and the present technology is not limited to the use directed to the inside of the company or the outside of the company. For example, it is also possible to prepare templates for friend, family, customer, public speech, face-to-face business, conference, presentation, phone call and the like.

### [1-5-2. Template Presentation Processing]

Next, processing of presenting the set template to the user by the presentation processing unit 220 will be described. The user can perform speech practice while viewing the presented template, or can speak while viewing the template in actual speech.

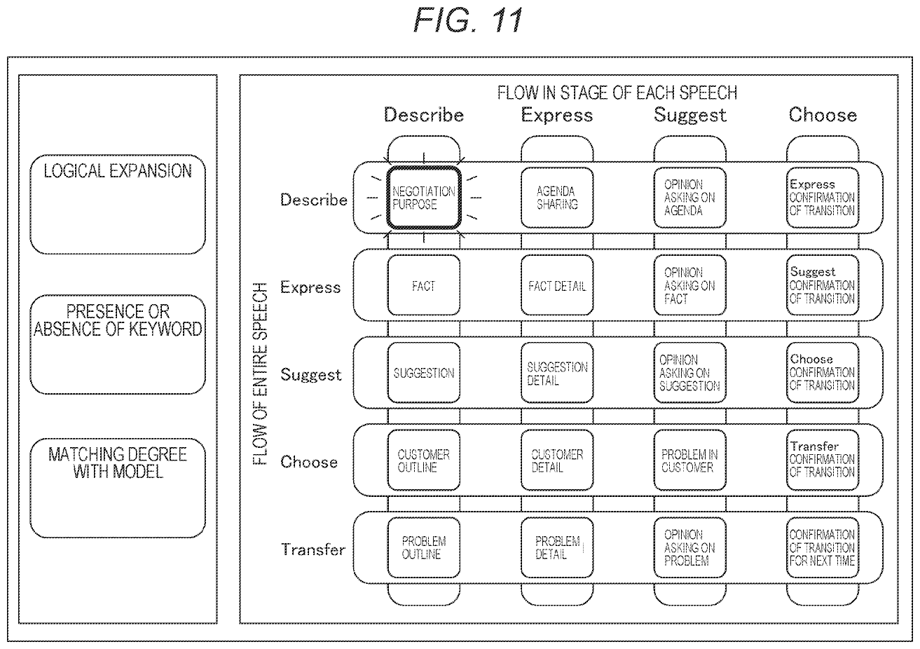

FIG. 11 illustrates a first aspect of a template presentation method. The first presentation aspect is a presentation aspect for a beginner. In the first presentation aspect, all the items forming the template and the order in which the items should be spoken are simultaneously displayed on the display unit 105 of the terminal device 100 and presented to the user. Note that, the presentation aspect in FIG. 11 is not limited to the beginner, and may be used for other user such as an expert.

In a case where all the items forming the template are displayed on the display unit 105 as in the first presentation aspect, the item that the user should speak now may be displayed in a highlighted manner so that the item can be distinguished from other items so that the user can understand the item as illustrated by the item “negotiation purpose” in FIG. 11. To display in the highlighted manner is, for example, to flash, change color, invert black and white, densely display, and display other items lightly, but any display mode may be used as long as the item may be distinguished from other items.

The presentation processing unit 220 may present options of the beginner or the expert to the user and allow the user to select any one of them, and set whether the user is the beginner or the expert on the basis of a selection result. Furthermore, classification of whether or not the user is the beginner or the expert may be automatically determined on the basis of information regarding the user. Examples of the information regarding the user include a profile of the user, a history and experience information of the user input by the user, and an answer to a question given to the user.

Note that, the classification of the user is not limited to two including the beginner and the expert, and may be three or more.

Note that, in order to perform the template presentation processing, it is necessary to set in advance a keyword to be detected from the utterance content of the user. The keyword includes a first keyword for making a transition to a next item and a second keyword for adding an item.

The first keyword includes, for example, a word, a sentence, a conjunction and the like such as “next”, “go to next”, and “lastly”. The second keyword includes, for example, a word, a sentence, a conjunction and the like such as “first” and “second”. Note that, these keywords are merely examples, and the present technology is not limited to these keywords. Note that, the first keyword is not necessarily one word, sentence, conjunction and the like, and it is possible to set a plurality of words, sentences, conjunctions and the like as the first keyword, and proceed the processing according to the first keyword when any of them is detected. It is similar in the second keyword.

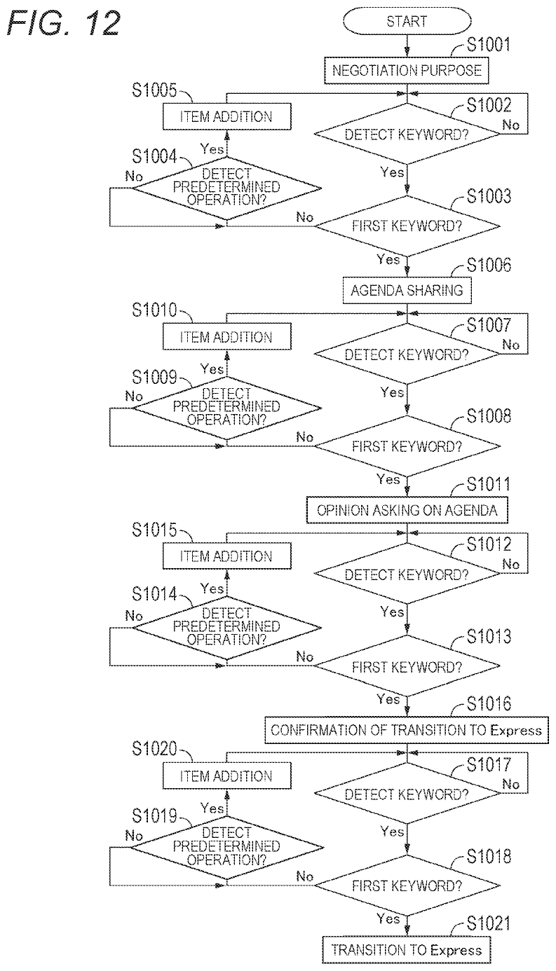

When the template is displayed on the display unit 105 to be presented as illustrated in FIG. 11, first, by processing of a flowchart illustrated in FIG. 12, processing of displaying the items in the row of “Describe” to present is performed.

First, at step S1001, processing of presenting “negotiation purpose”, which is the first item in the row of “Describe”, as the item that the user should speak is performed. As described above, the processing of presenting as the item is processing of displaying the item while distinguishing the same so that the user can understand that the item is the item that the user should speak now. When the item “negotiation purpose” is presented as the item that should be spoken, the user speaks about the negotiation purpose.

Next, in a case where the keyword is detected from the utterance content of the user at step S1002, the processing proceeds to step S1003 (Yes at step S1002). In a case where the detected keyword is not the first keyword, that is, in a case where this is the second keyword, the processing proceeds to step S1004 (No at step S1003).

Next, in a case where a predetermined operation of the user is detected at step S1004, the processing proceeds to step S1005 (Yes at step S1004). The predetermined operation is, for example, the input to the input unit 104, a blink, movement of a line-of-sight to a specific position on a display surface of the display unit 105, the input of a predetermined keyword by voice and the like. The blink and the movement of the line-of-sight can be detected from the image or video obtained by imaging the state of the user who is speaking by the camera 106, using a known detecting technology. Note that, the detection of the predetermined operation is not essential processing. In a case where the second keyword is detected, item addition processing at step S1005 may be performed without detecting the predetermined operation. However, by detecting the predetermined operation, it is possible to avoid addition of an item not intended by the user.

Then, at step S1005, the item “negotiation purpose” is added and there are two items. Note that, the presentation processing unit 220 may have a known subject recognition function for detecting the predetermined movement, or the information processing device 200 may include an independent processing unit that performs subject recognition.

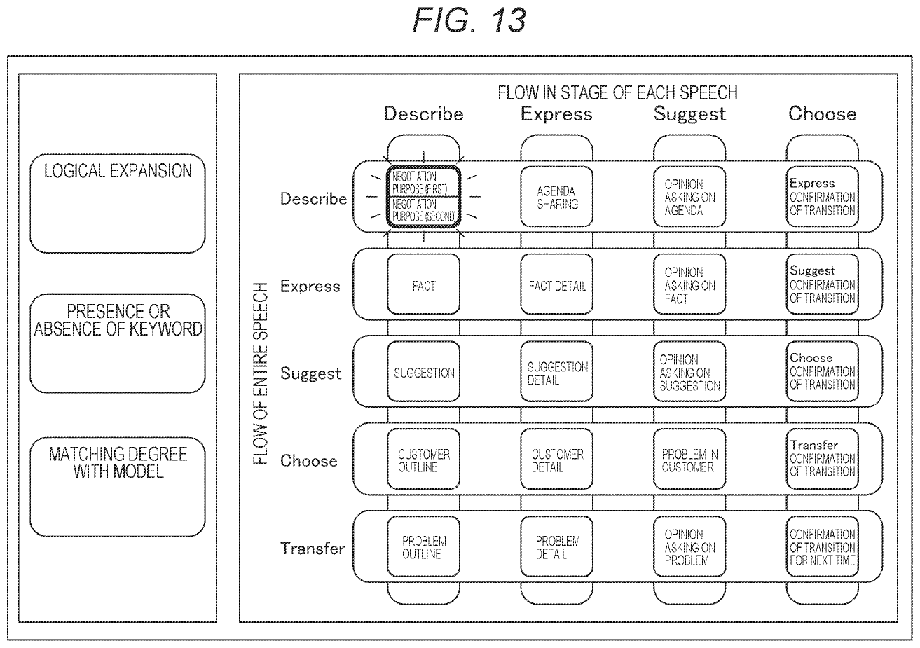

Each item is formed to correspond to one utterance content of the user, and the template is formed in such a manner that all the items correspond to one utterance content in an initial state. However, there is a case where the user wants to speak about two or more contents for one item. For example, this is a case where the user wants to speak about two contents as the negotiation purpose. In this case, the user needs to utter the second keyword and perform a predetermined operation so that the item addition processing at step S1005 is performed. By performing the item addition processing at step S1005, it is possible to add the “negotiation purpose”, which is the current item, to obtain the two items as illustrated in FIG. 13. As a result, the user can speak about two contents as the negotiation purposes. Note that, the item “negotiation purpose” is added to increase as long as the second keyword is detected and step S1006 is repeated.

In contrast, in a case where the detected keyword is the first keyword, the processing proceeds to step S1006 (Yes at step S1003).

Next, at step S1006, processing of making a transition of the item that should be spoken to “agenda sharing”, which is the second item in the row of “Describe”, to present is performed. When the item “agenda sharing” is presented as the item that should be spoken, the user speaks about the agenda sharing.

Next, in a case where the keyword is detected from the utterance content of the user at step S1007, the processing proceeds to step S1008 (Yes at step S1007). In a case where the detected keyword is not the first keyword, that is, in a case where this is the second keyword, the processing proceeds to step S1009 (No at step S1008).

Next, in a case where a predetermined operation of the user is detected at step S1009, the processing proceeds to step S1010 (Yes at step S1009). Then, at step S1010, the item “agenda sharing” is added and there are two items. Note that, the item “agenda sharing” is added to increase as long as the second keyword is detected and step S1010 is repeated.

In contrast, in a case where the detected keyword is the first keyword, the processing proceeds to step S1011 (Yes at step S1008).

Next, at step S1011, processing of presenting “opinion asking on agenda”, which is the third item in the row of “Describe”, as the item that should be spoken is performed. When the item “opinion asking on agenda” is presented as the item that should be spoken, the user speaks about the opinion asking on agenda.

Next, in a case where the keyword is detected from the utterance content of the user at step S1012, the processing proceeds to step S1013 (Yes at step S1012). In a case where the detected keyword is not the first keyword, that is, in a case where this is the second keyword, the processing proceeds to step S1014 (No at step S1013).

Next, in a case where a predetermined operation of the user is detected at step S1014, the processing proceeds to step S1015 (Yes at step S1014). Then, at step S1015, the item “opinion asking on agenda” is added and there are two items. Note that, the item “opinion asking on agenda” is added to increase as long as the second keyword is detected and step S1015 is repeated.

In contrast, in a case where the detected keyword is the first keyword, the processing proceeds to step S1016 (Yes at step S1013).

Next, at step S1016, processing of presenting “confirmation of transition to Express”, which is the fourth item in the row of “Describe”, as the item that should be spoken is performed. When the item “confirmation of transition to Express” is presented as the item that should be spoken, the user speaks about the confirmation of transition to Express.

Next, in a case where the keyword is detected from the utterance content of the user at step S1017, the processing proceeds to step S1018 (Yes at step S1017). In a case where the detected keyword is not the first keyword, that is, in a case where this is the second keyword, the processing proceeds to step S1019 (No at step S1018).

Next, in a case where a predetermined operation of the user is detected at step S1019, the processing proceeds to step S1020 (Yes at step S1019). Then, at step S1020, the item “confirmation of transition to Express” is added and there are two items. Note that, the item “confirmation of transition to Express” is added to increase as long as the second keyword is detected and step S1020 is repeated.

In contrast, in a case where the detected keyword is the first keyword, the processing proceeds to step S1021 (Yes at step S1018). Then, at step S1021, the processing proceeds to processing of presenting the items in a row of Express.

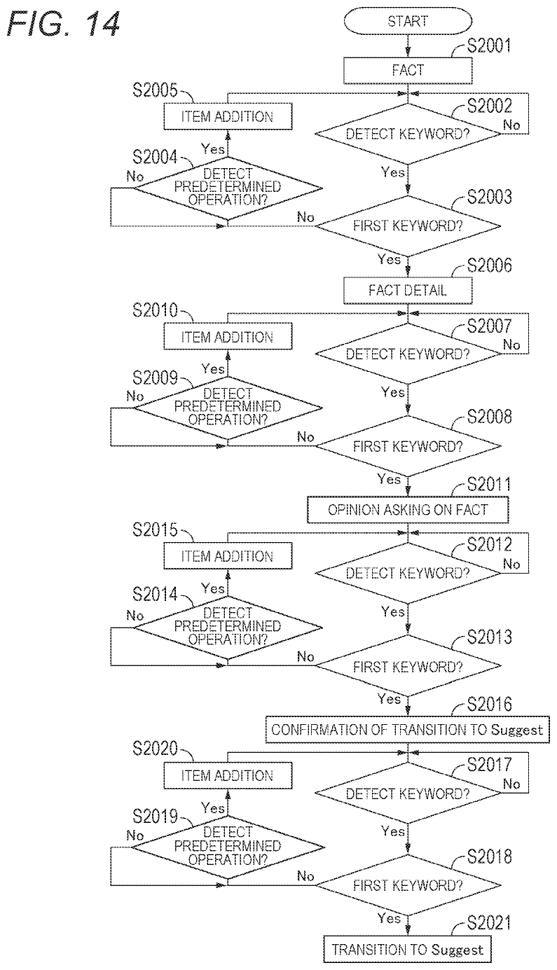

Next, the presentation processing unit 220 performs processing of displaying and presenting the items in the row of “Express” by processing of a flowchart illustrated in FIG. 14. The processing of presenting the items in the row of “Express” is configured by a processing step of making a transition to a next item in a case where the first keyword is detected from the utterance content of the user and adding an item at that time in a case where the second keyword is detected, similarly to the processing of presenting the items in the row of “Describe” described above.

The items in the row of “Express” are displayed in the order of fact, fact detail, opinion asking on fact, and confirmation of transition to Suggest and presented to the user by the processing in FIG. 14.

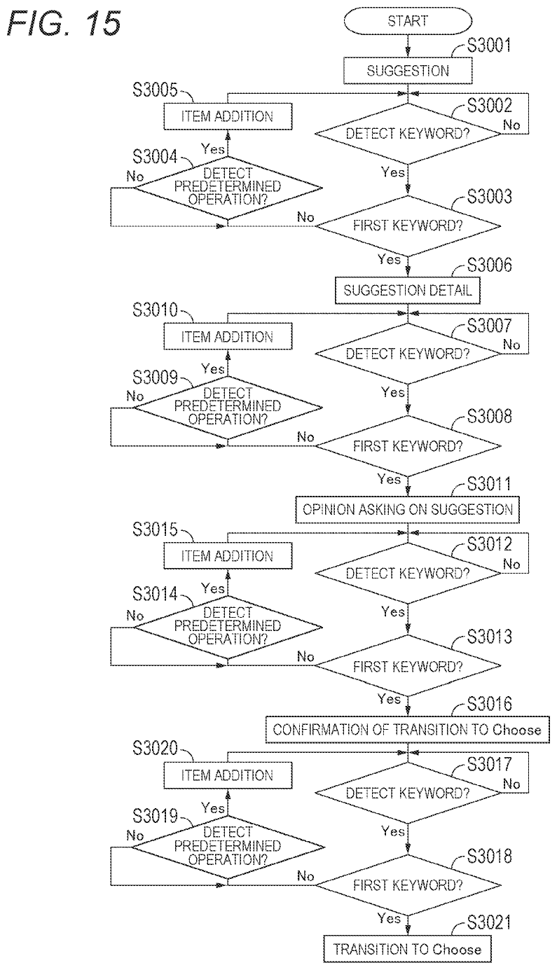

After performing the presentation processing of the items in the row of “Express”, the presentation processing unit 220 next performs processing of displaying and presenting the items in the row of “Suggest” by processing of a flowchart illustrated in FIG. 15. The processing of presenting the items in the row of “Suggest” is configured by a processing step of making a transition to a next item in a case where the first keyword is detected from the utterance content of the user and adding an item at that time in a case where the second keyword is detected, similarly to the processing of presenting the items in the row of “Describe” described above.

The items in the row of “Suggest” are displayed in the order of suggestion, suggestion detail, opinion asking on suggestion, and confirmation of transition to Choose and presented to the user by the processing in FIG. 15.

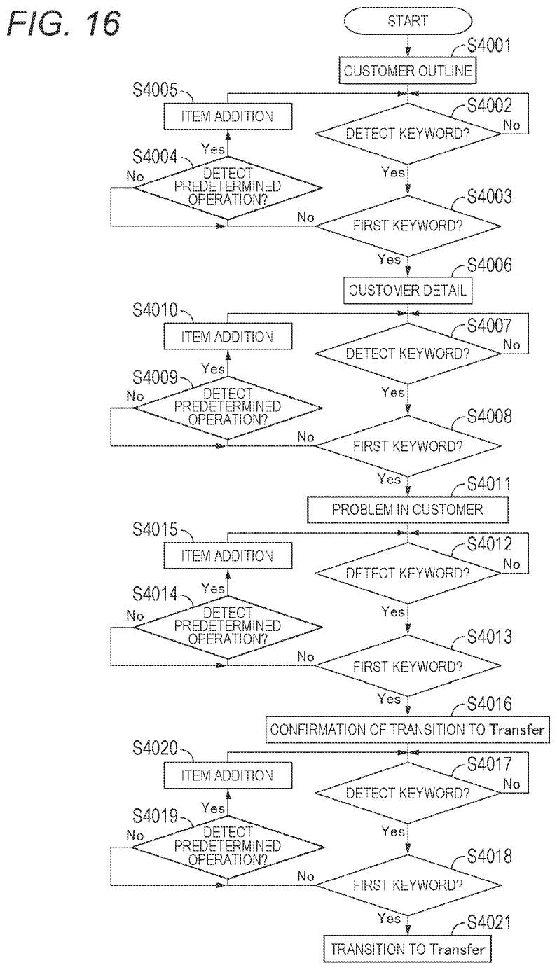

After performing the presentation processing of the items in the row of “Suggest”, the presentation processing unit 220 next performs processing of displaying and presenting the items in the row of “Choose” by processing of a flowchart illustrated in FIG. 16. The processing of presenting the items in the row of “Choose” is configured by a processing step of making a transition to a next item in a case where the first keyword is detected from the utterance content of the user and adding an item at that time in a case where the second keyword is detected, similarly to the processing of presenting the items in the row of “Describe” described above.

The items in the row of “Choose” are displayed in the order of customer outline, customer detail, problem in customer, and confirmation of transition to Transfer and presented to the user by the processing in FIG. 16.

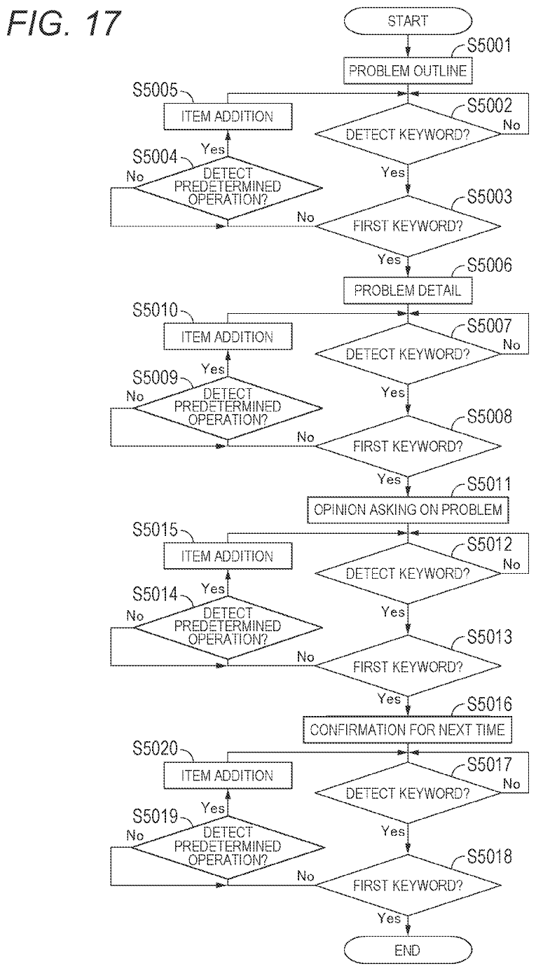

After performing the presentation processing of the items in the row of “Choose”, the presentation processing unit 220 next performs processing of displaying and presenting the items in the row of “Transfer” by processing of a flowchart illustrated in FIG. 17. The processing of presenting the items in the row of “Transfer” is configured by a processing step of making a transition to a next item in a case where the first keyword is detected from the utterance content of the user and adding an item at that time in a case where the second keyword is detected, similarly to the processing of presenting the items in the row of “Describe” described above.

The items in the row of “Transfer” are displayed in the order of problem outline, problem detail, opinion asking on problem, and confirmation of transition for next time and presented to the user by the processing in FIG. 17.

The entire template presentation processing may be finished when the processing is performed on the last item in the order, or the template presentation processing may be finished in a case where a third keyword is detected from the utterance content of the user. Examples of the third keyword include, for example, “finish”, “over” and the like.

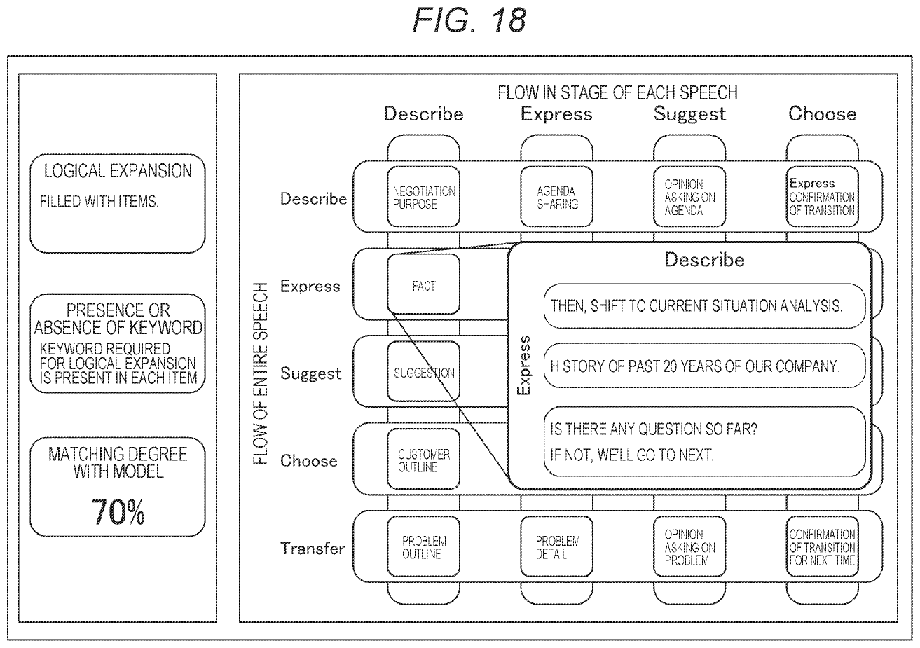

When the template is presented, an example sentence in each item may be displayed and presented to the user as illustrated in FIG. 18. The user can efficiently practice the speech by practicing while viewing this example sentence, and can learn a specific and optimal utterance content in the item. Furthermore, in the actual speech, the user can surely speak the content that the user should speak by speaking while viewing this example sentence.

The template setting unit 210 generates and sets an example sentence of each item from a model script, an utterance content of other excellent user and the like. For example, the template setting unit 210 extracts a model script or a part of the utterance content of other user on the basis of an item name to obtain an example sentence. Note that, from the viewpoint of privacy and the like, there may be a limitation that the example sentence can be generated from the utterance content of other user only in a case where the other user gives permission. Furthermore, the template setting unit 210 may generate an example sentence that is an optimal model in accordance with, for example, information of a speech partner, time, or an achievement degree of the user himself/herself.

The model script may be input by the user via the terminal device 100, or may be input by the business operator and the like that provides a service using the information processing device 200. The model script may be text data, voice data, or video data including voice. In a case where the model script is voice data or video data, the template setting unit 210 performs morpheme analysis, syntax analysis, semantic analysis and the like on the data to extract the text data, generates an example sentence from the text data to set.

The presentation of the example sentence is especially useful in a case where the user is a beginner, but the example sentence may be presented also in a case where the user is an expert. The user may be allowed to select whether or not to present the example sentence.

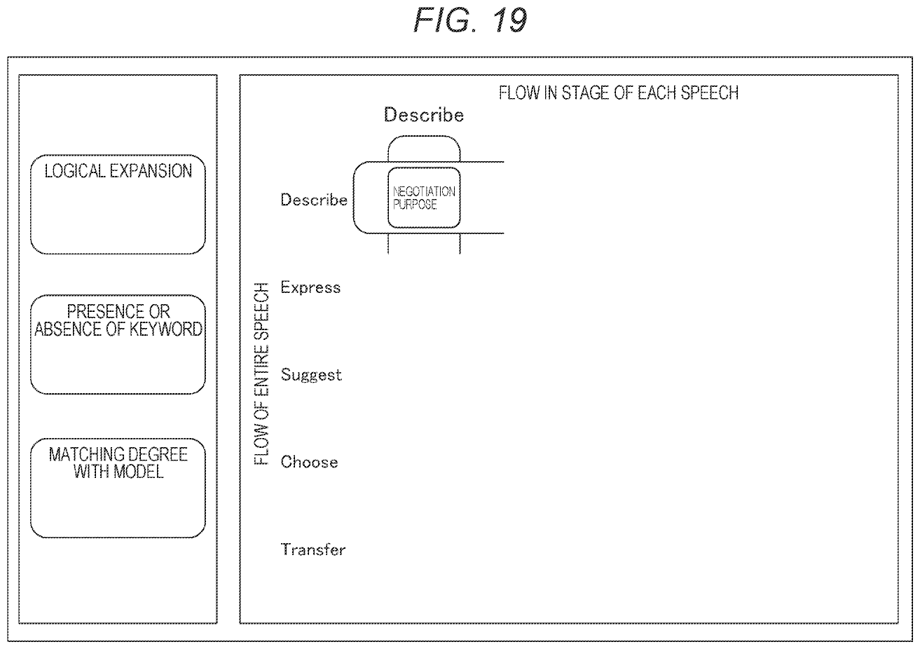

FIG. 19 illustrates a second aspect of a template presentation method. The second presentation aspect is a presentation aspect for an expert. In the second presentation aspect, first, only one item is displayed and presented to the user as illustrated in FIG. 19.

In the second presentation aspect, not all the items are displayed at once and presented to the user, but the items are displayed one by one and presented to the user according to the order in which the user should speak.

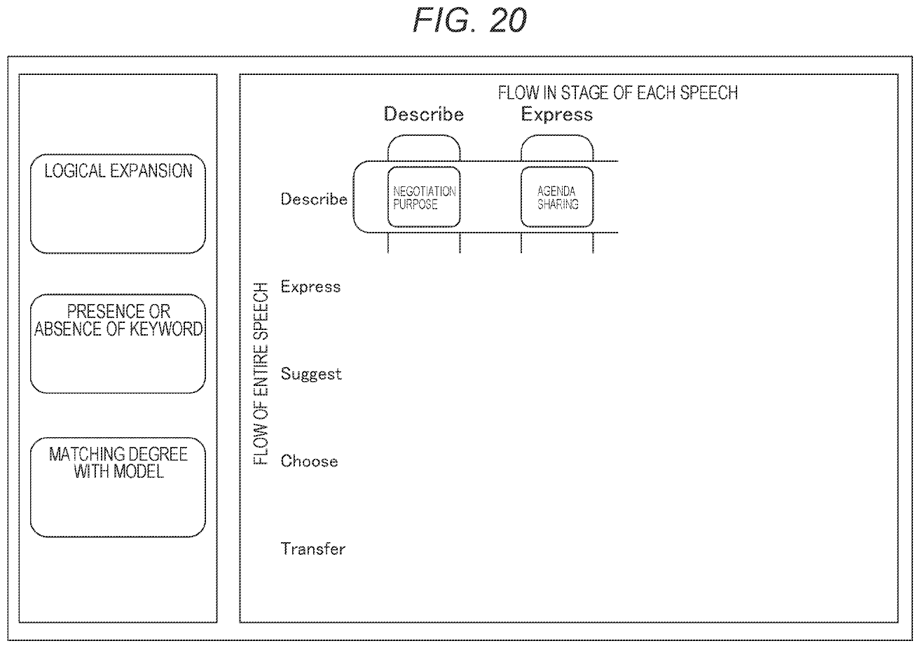

When the user utters the first keyword and makes a transition to a next item, the next item is displayed and presented to the user as illustrated in FIG. 20. In this manner, the items are displayed one by one up to the last item according to the order and presented to the user.

Since the information to be presented to the user is limited by presenting the items in this manner, the user can perform practice for an expert. Note that, the template may be presented as illustrated in FIGS. 19 and 20 also in the actual speech. Furthermore, the second presentation aspect illustrated in FIGS. 19 and 20 is not limited to the expert, and may be used for other user such as the beginner.

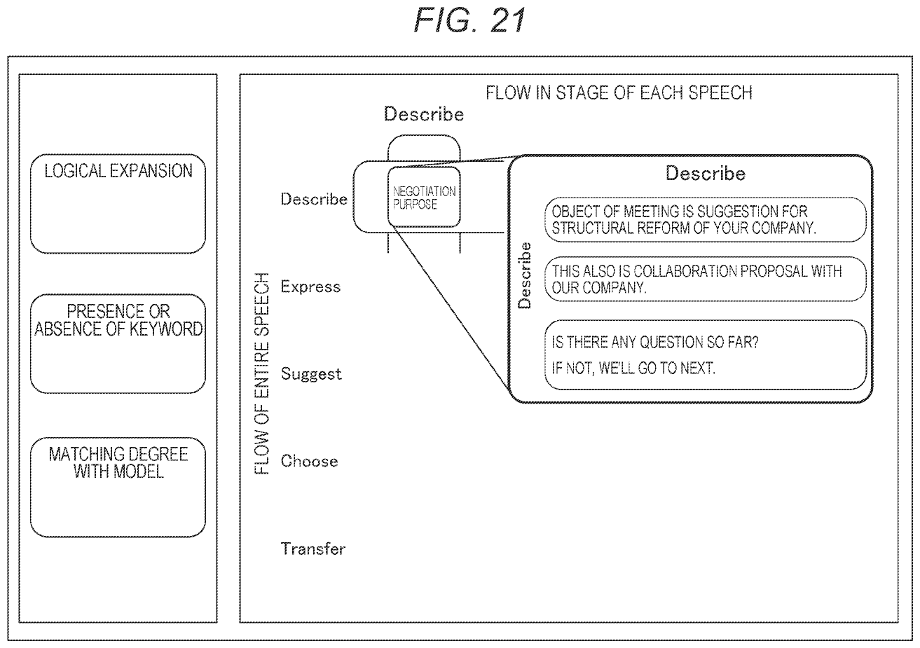

Note that, as illustrated in FIG. 21, also in the second presentation aspect of the template, an example sentence in the item may be presented.

Furthermore, in the presentation aspect for the expert, it is also possible to allow the user to speak without presenting any item forming the template at all, and perform evaluation by comparing the utterance content of the user with the template.

In both the first presentation aspect and the second presentation aspect of the template, evaluation information calculated by the evaluation processing unit 230 is displayed together with the template and presented to the user. As illustrated in FIG. 18, the evaluation information includes logical expansion, presence or absence of a keyword, a matching degree with a model and the like. The evaluation information may be evaluation of each item, evaluation of the entire template, or both the evaluation of each item and evaluation of the entire template.

The “logical expansion” is evaluation from the viewpoint of whether or not the items forming the template are spoken in order to fill an element (keyword) in the item. The “presence or absence of a keyword” is an evaluation from the viewpoint of, in a case where the element (keyword) as the example sentence is set for each item, whether or not the user speaks the element (keyword).

Furthermore, the text data indicating the utterance content stored by the storage processing unit 236 may be displayed together with the evaluation and presented to the user. As a result, the user can confirm his/her own utterance content later.

The processing according to the present technology is performed as described above. According to the present technology, it is possible to set the template according to the speech partner, the speech content, the speech type and the like, and the user can practice speaking without logical or constructive contradiction in accordance with the template. Furthermore, not only the practice but also the support or aid in the actual speech can be provided to the user. Moreover, the user can also review after the practice or actual speech using the present technology.

Furthermore, the user can objectively improve his/her own speech by confirming a difference between the script of other excellent person and his/her own speech. Furthermore, it is possible to laterally develop know-how of personal speaking. Moreover, cost reduction can be achieved as compared with man-to-man training, and continuous training can be performed.

### 2. Variation

Although the embodiment of the present technology has been specifically described above, the present technology is not limited to the above-described embodiment, and various modifications based on the technical idea of the present technology are possible.

In the embodiment, it has been described that the information processing device 200 is implemented by processing in the server device 300, and the speech practice method and the support are provided to the user as the cloud service; however, the information processing device 200 may be implemented by processing in the terminal device 100. In that case, it is not necessary to transmit the utterance content and the image or video of the utterance state of the user to the server device 300. Furthermore, the information processing device 200 may be implemented by processing in a device other than the terminal device 100 and the server device 300.

The present technology can also have the following configurations.
(1)

An information processing device including:

a template setting unit that sets a plurality of items forming a speech and an order in which the items should be spoken as a speech template; and

a presentation processing unit that performs processing of presenting the template to a user.
(2)

The information processing device according to (1), in which the template setting unit sets the template on the basis of a type of a speech performed by the user.
(3)

The information processing device according to (1) or (2), in which the template setting unit sets the template according to a speech partner of the user.
(4)

The information processing device according to any one of (1) to (3), in which the template setting unit sets the template on the basis of a relationship between a speech partner of the user and the user.
(5)

The information processing device according to any one of (1) to (4), in which the template setting unit sets the template according to a content of a speech performed by the user.
(6)

The information processing device according to any one of (1) to (5), in which the presentation processing unit performs processing to simultaneously present all of the plurality of items.
(7)

The information processing device according to (6), in which the presentation processing unit performs processing to highlight an item that the user should speak out of the plurality of items to present.
(8)

The information processing device according to any one of (1) to (7), in which the presentation processing unit performs processing to present the plurality of items one by one in the order.
(9)

The information processing device according to any one of (1) to (8), in which in a case where a first keyword is detected from an utterance content of the user, the presentation processing unit makes a transition of an item that the user should speak in the plurality of items to a next item to present.
(10)

The information processing device according to any one of (1) to (9), in which in a case where a second keyword is detected from an utterance content of the user, the template setting unit adds a content of an item that the user should speak at that time.
(11)

The information processing device according to any one of (1) to (10), in which the presentation processing unit classifies the user as an expert or a beginner, performs processing so as to simultaneously present all of the plurality of items to the user classified as the beginner, and performs processing so as to present the plurality of items one by one according to the order to the user classified as the expert.
(12)

The information processing device according to any one of (1) to (11), in which the template setting unit sets example sentences corresponding to the items.
(13)

The information processing device according to (12), in which the template setting unit generates the example sentences on the basis of a model script.
(14)

The information processing device according to (12), in which the template setting unit generates the example sentences on the basis of an utterance content of a user other than the user.
(15)

The information processing device according to (12), in which the presentation processing unit performs processing to also present the example sentences when presenting the plurality of items.
(16)

The information processing device according to any one of (1) to (15), further including an evaluation processing unit that evaluates an utterance content of the user on the basis of the template.
(17)

The information processing device according to (16), in which the evaluation processing unit evaluates the utterance content on the basis of a comparison result between the template and the utterance content.
(18)

The information processing device according to any one of (1) to (17), further including a storage processing unit that performs processing of storing an utterance content of the user so as to correspond to the items.
(19)

An information processing method including:

setting a plurality of items forming a speech and an order in which the items should be spoken as a speech template; and performing processing of presenting the template to a user.
(20)

A program that allows a computer to execute an information processing method including:

setting a plurality of items forming a speech and an order in which the items should be spoken as a speech template; and

performing processing of presenting the template to a user.

### REFERENCE SIGNS LIST

200 Information processing device
201 Template setting unit
202 Presentation processing unit
203 Evaluation processing unit

1. An information processing device comprising:
a template setting unit that sets a plurality of items forming a speech and an order in which the items should be spoken as a speech template; and
a presentation processing unit that performs processing of presenting the template to a user.

2. The information processing device according to claim 1, wherein
the template setting unit sets the template on a basis of a type of a speech performed by the user.

3. The information processing device according to claim 1, wherein
the template setting unit sets the template according to a speech partner of the user.

4. The information processing device according to claim 1, wherein
the template setting unit sets the template on a basis of a relationship between a speech partner of the user and the user.

5. The information processing device according to claim 1, wherein
the template setting unit sets the template according to a content of a speech performed by the user.

6. The information processing device according to claim 1, wherein
the presentation processing unit performs processing to simultaneously present all of the plurality of items.

7. The information processing device according to claim 6, wherein
the presentation processing unit performs processing to highlight an item that the user should speak out of the plurality of items to present.

8. The information processing device according to claim 1, wherein
the presentation processing unit performs processing to present the plurality of items one by one in the order.

9. The information processing device according to claim 1, wherein
in a case where a first keyword is detected from an utterance content of the user, the presentation processing unit makes a transition of an item that the user should speak in the plurality of items to a next item to present.

10. The information processing device according to claim 1, wherein
in a case where a second keyword is detected from an utterance content of the user, the template setting unit adds a content of an item that the user should speak at that time.

11. The information processing device according to claim 1, wherein
the presentation processing unit classifies the user as an expert or a beginner, performs processing so as to simultaneously present all of the plurality of items to the user classified as the beginner, and performs processing so as to present the plurality of items one by one according to the order to the user classified as the expert.

12. The information processing device according to claim 1, wherein
the template setting unit sets example sentences corresponding to the items.

13. The information processing device according to claim 12, wherein
the template setting unit generates the example sentences on a basis of a model script.

14. The information processing device according to claim 12, wherein
the template setting unit generates the example sentences on a basis of an utterance content of a user other than the user.

15. The information processing device according to claim 12, wherein
the presentation processing unit performs processing to also present the example sentences when presenting the plurality of items.

16. The information processing device according to claim 1, further comprising
an evaluation processing unit that evaluates an utterance content of the user on a basis of the template.

17. The information processing device according to 16, wherein
the evaluation processing unit evaluates the utterance content on a basis of a comparison result between the template and the utterance content.

18. The information processing device according to claim 1, further comprising
a storage processing unit that performs processing of storing an utterance content of the user so as to correspond to the items.

19. An information processing method comprising:
setting a plurality of items forming a speech and an order in which the items should be spoken as a speech template; and
performing processing of presenting the template to a user.

20. A program that allows a computer to execute an information processing method comprising:
setting a plurality of items forming a speech and an order in which the items should be spoken as a speech template; and
performing processing of presenting the template to a user.
